(19) United States
(12) Patent Application Publication
(10) Pub. No.: US 2018/0275912 A1
(43) Pub. Date: Sep. 27, 2018

(54) INFORMATION PROCESSING APPARATUS AND METHOD FOR CONTROLLING THE SAME

(71) Applicant: CANON KABUSHIKI KAISHA, Tokyo (JP)

(72) Inventor: Yuichi Konosu, Saitama-shi (JP)

(21) Appl. No.: 15/919,753

(22) Filed: Mar. 13, 2018

(30) Foreign Application Priority Data
Mar. 21, 2017 (JP) 2017-054884

(51) Int. Cl. G06F 3/06

(52) U.S. Cl. CPC G06F 3/0647; G06F 3/0616; G06F 3/0659; G06F 3/0653; G06F 3/068; G06F 3/0652

(57) ABSTRACT

When a device life of the eMMC or the SSD becomes short, a swap function is turned off or restricted.

### BACKGROUND OF THE INVENTION

### Field of the Invention

The aspect of the embodiments relates to an information processing apparatus and a method for controlling the information processing apparatus.

### Description of the Related Art

In recent years, apparatuses including a NAND type flash memory, such as an embedded multimedia card (eMMC) or a solid state drive (SSD) as storage have been widely used. The eMMC is formed by an NAND type flash memory and is superior to general storage in terms of heating, operation noise, impact-resistance, power consumption, and a size. Furthermore, the eMMC is standardized by Joint Electron Device Engineering Council (JEDEC) which is a group defining standards of semiconductor components, and therefore, is easily employed. However, the eMMC has limitation for the number of times writing is performed since the eMMC is a flash memory, and therefore, a durable life (life) as storage is short.

Furthermore, NAND type flash memories which have limitation for at least one of the number of times writing is performed, the number of times reading is performed, and the number of times deleting is performed have been used. Specifically, a technique of transmitting an alert to a NAND type flash memory before the number of times deleting is performed in the NAND type flash memory reaches the upper limit of the number of times deleting may be performed in the NAND type flash memory has been disclosed (Japanese Patent Laid-Open No. 2011-186553).

### SUMMARY OF THE INVENTION

According to an aspect of the embodiments, an apparatus including a volatile memory and a nonvolatile storage device includes a controller configured to control a swap process of saving data stored in the volatile memory into a swap region included in the nonvolatile storage device and a restriction unit configured to restrict the swap process in accordance with information on a life of the nonvolatile storage device.

Further features of the disclosure will become apparent from the following description of exemplary embodiments with reference to the attached drawings.

### BRIEF DESCRIPTION OF THE DRAWINGS

FIG. 1 is a block diagram illustrating an example of an image forming apparatus according to an embodiment.

FIG. 2 is a flowchart of swap-out included in a swap function according to the embodiment.

FIG. 3 is a flowchart of swap-in included in the swap function according to the embodiment.

FIG. 4 is a flowchart of a process of turning off the swap function when device life information is equal to or larger than a certain value according to the embodiment.

FIG. 5 is a flowchart of a process of restricting the swap function in accordance with the device life information according to the embodiment.

FIG. 6 is a table illustrating an example of mapping of a device life information register based on the eMMC standard according to the embodiment.

FIG. 7 is a diagram illustrating an example of a swap frequency setting value included in an operating system (OS) according to the embodiment.

FIG. 8 is a diagram illustrating an example of a partition setting of an eMMC and an SSD according to the embodiment.

FIG. 9 is a block diagram illustrating an example of software according to the embodiment.

### DESCRIPTION OF THE EMBODIMENTS

An embodiment of the present disclosure will be described hereinafter with reference to the accompanying drawings.

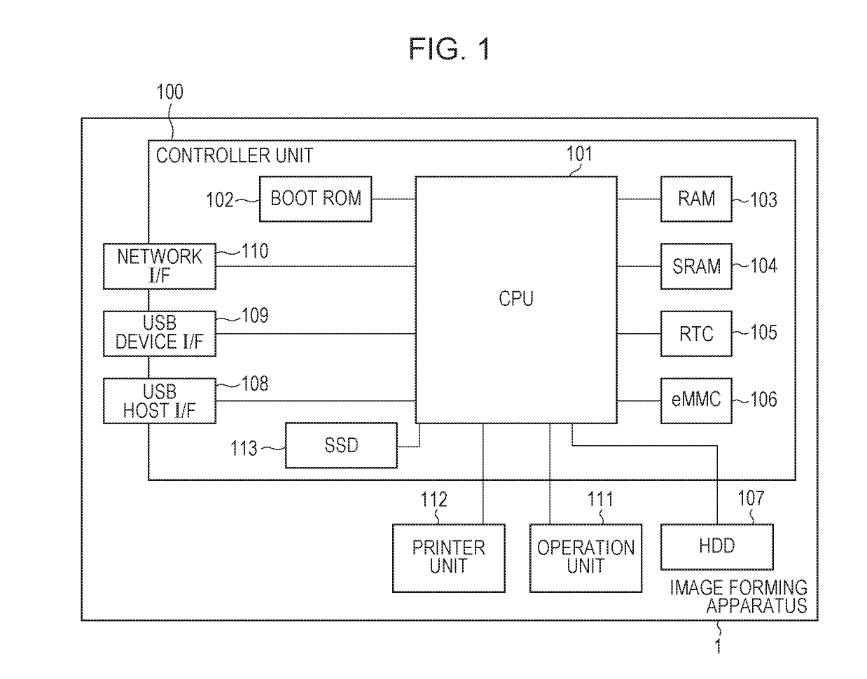

FIG. 1 is a block diagram illustrating an example of an image forming apparatus 1.

The image forming apparatus 1 is configured as below. Specifically, the image forming apparatus 1 includes a multifunction peripheral (MFP) and a printer which employ an electrophotographic method or an inkjet method. The image forming apparatus 1 includes an operation unit 111 used to perform operation and display of the image forming apparatus 1.

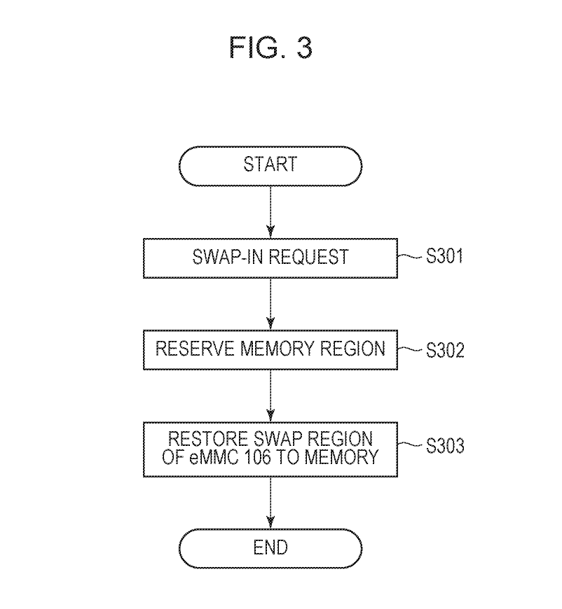

The image forming apparatus 1 further includes a printer unit 112 which is an engine which outputs a digital image to a paper device. The image forming apparatus 1 further includes a controller unit 100 which controls various devices and various units. The controller unit 100 is a hardware system circuit including a central processing unit (CPU), for example. Although a general CPU may be used, the general CPU serves as a processor which realizes a specific usage disclosed in this embodiment by executing this embodiment. A CPU 101 which controls the entire image forming apparatus 1, a boot ROM 102 which includes a boot program, and a random access memory (RAM) 103 used by the controller unit 100 as a work memory are disclosed. Furthermore, a static RAM (SRAM) 104 which may retain data including setting information required for operating the image forming apparatus 1 even when power supply is blocked is disclosed. A real-time clock (RTC) 105 having a time counting function is also disclosed. Furthermore, the following devices are disclosed as storage for storing programs to be executed by the CPU 101 and various data. For example, an eMMC 106 used by the CPU 101 as main storage and a detachable hard disk drive (HDD) 107 which stores data as sub-storage are disclosed. A reference numeral 113 denotes a solid state drive (SSD). Although a description is made taking the eMMC 106 as an example, the same is true of the SSD 113 unless otherwise specified. Specifically, the eMMC 106 illustrated in FIGS. 3, 4, 5, 8, and 9 may be basically replaced by the SSD 113, for example.

The image forming apparatus 1 has the following configuration. For example, the image forming apparatus 1 includes a universal serial bus (USB) host interface (I/F) 108 which is connectable to a USB device, such as a USB memory or a USB card reader. The image forming apparatus 1 further includes a USB device I/F 109 which is connectable to an external apparatus through a USB cable and a network I/F 110 which is connectable to an external network through a wired local area network (LAN) or a wireless LAN.

For example, the CPU 101 includes a large number of hardware devices in the vicinity of the CPU 101, such as a chip set, a bus bridge, and a clock generator. However, this embodiment is not limited to this block configuration. Operation of the controller unit 100 will now be described taking image printing using a paper device as an example.

When a user instructs image printing using an external apparatus, such as a personal computer (PC) or a USB memory through the various I/Fs, the CPU 101 performs DMA transfer to the RAM 103 and temporarily stores digital image data.

When recognizing that a certain amount of or all the digital image data is stored in the RAM 103, the CPU 101 issues an image output instruction to the printer unit 112. The CPU 101 indicates a position of the image data in the RAM 103, the image data in the RAM 103 is transmitted to the printer unit 112 in accordance with a synchronization signal supplied from the printer unit 112, and the digital image data is printed on a paper device by the printer unit 112.

When a plurality of copies are to be printed, the CPU 101 may store the image data stored in the RAM 103 in the eMMC 106 or the HDD 107 and transmit an image to the printer unit 112 without a request for transmitting the image issued by an external apparatus after a second copy onwards.

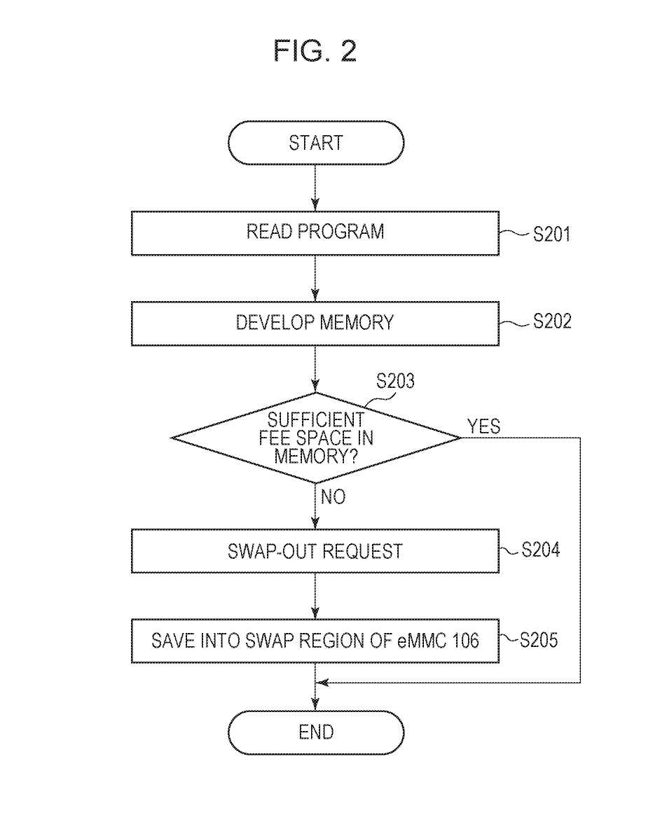

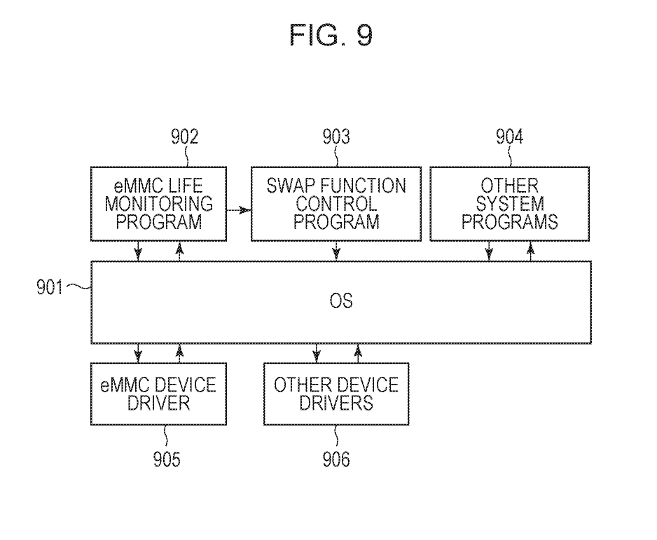

FIG. 2 is an example of a flowchart of swap-out included in a swap function. In the swap-out, a program (a process) which is not being used is temporarily saved in a region of storage when physical memory capacity of an operating system (OS) 901 is lacked. A process in FIG. 2 is started when the OS 901 (in FIG. 9) issues an instruction to the CPU 101 after a certain swap-out condition is satisfied. The CPU 101 of the image forming apparatus 1 reads a program (including data) stored in the eMMC 106 (S201). Then the program is developed in the RAM 103 and executed (S202).

When the CPU 101 determines that the RAM 103 does not have a sufficient space (S203: No), the OS 901 issues a swap-out request to the CPU 101 (S204). The CPU 101 which has received the swap-out request temporarily saves a program which is not used in the RAM 103 in a swap region which is reserved in advance in the eMMC 106 (S205). When the CPU 101 determines that the RAM 103 has a sufficient space (S203: Yes), the CPU 101 terminates the process.

FIG. 3 is an example of a flowchart of swap-in included in the swap function. In the swap-in, a stored program which is temporarily saved in the region in the storage included in the OS 901 is restored in the memory. A process in FIG. 3 is started when the OS 901 issues an instruction to the CPU 101 after a certain swap-in condition is satisfied.

When the program which is swapped out is to be executed again, the OS 901 issues a swap-in request to the CPU 101 (S301). The CPU 101 which has received the swap-in request reserves a region for executing the stored program in the RAM 103 (S302).

The CPU 101 reads the stored program from the swap region of the eMMC 106 and develops (restores) the stored program in the region reserved in the RAM 103 in step S302 (S303).

Note that a specific OS has a function of turning off the swap function so that the swap-in and the swap-out are not performed. Frequency of the swap-out and the swap-in in FIGS. 2 and 3 may be set by assigning a parameter to a system call of Swappiness by the OS 901.

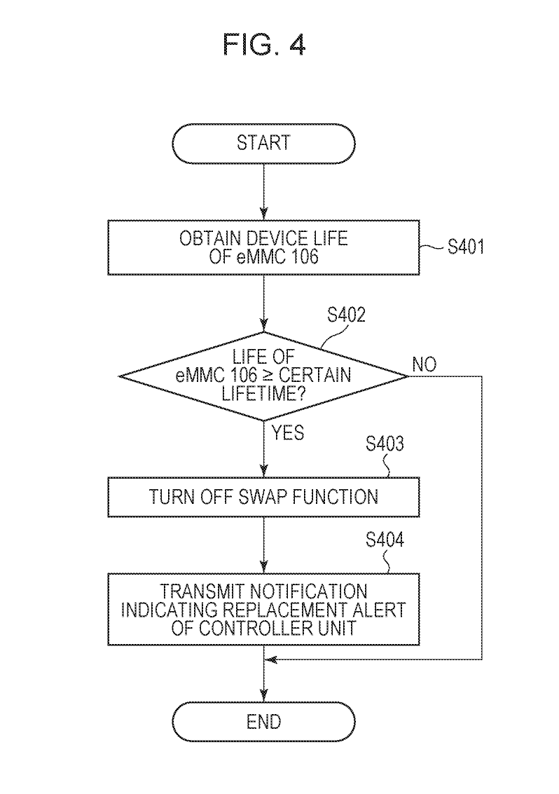

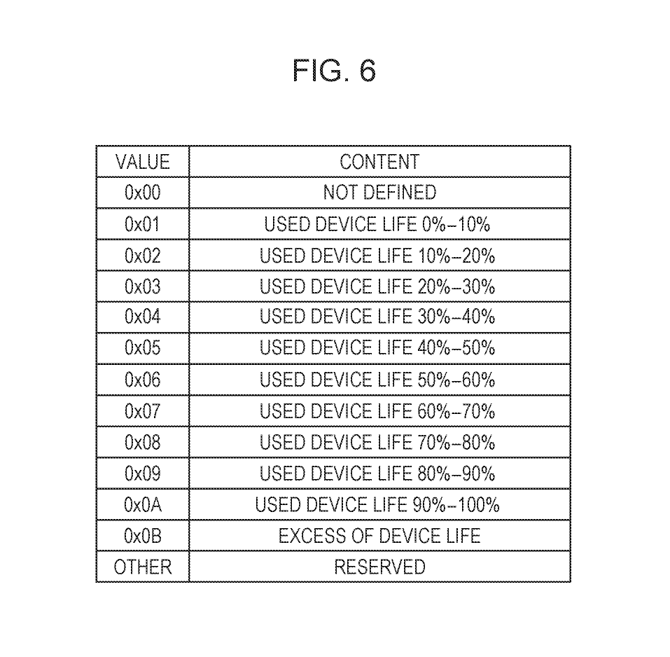

FIG. 4 is a flowchart of a process of turning off the swap function when device life information of the eMMC 106 is equal to or larger than a certain value according to the embodiment. The CPU 101 performs a process below under control of the OS 901, an eMMC life monitoring program 902, or the like. The eMMC life monitoring program 902 starts the following process periodically or in response to an instruction issued by the user. The CPU 101 obtains the device life information from the eMMC 106 under control of the eMMC life monitoring program 902 (S401). The CPU 101 determines whether the obtained device life information (refer to FIG. 6) is equal to or larger than a predetermined threshold value under control of the eMMC life monitoring program 902 (S402). When the determination is affirmative in step S402, the CPU 101 issues an instruction to a swap function control program 903 so as to turn off the swap function (S403). Specifically, the swap function control program 903 instructs the OS 901 to issue a system call so that the swap function is turned off based on a notification supplied from the eMMC life monitoring program 902. Furthermore, the CPU 101 controls a process of displaying a message which prompts replacement of the controller unit 100 in the operation unit 111 under control of the OS 901 (S404). Specifically, the swap function control program 903 instructs the OS 901 to display the replacement message.

When the OS 901 accesses the eMMC 106 at a time of activation, for example, a value of a device life register may be obtained. Here, when the obtained value is equal to or larger than 0x09 (Used Device Life: 80% to 90%), for example, the CPU 101 instructs the OS 901 to turn off the swap function in accordance with an instruction issued by the swap function control program 903. On the other hand, when the determination is negative in step S402, the process is terminated.

FIG. 6 is a table illustrating an example of information on the life of the eMMC 106. The mapping in FIG. 6 is based on JEDEC. Note that the eMMC standard defines correspondence between a numerical value indicating a rate and a value to be stored in a register. A method for calculating a numerical value (a value indicated by information associated with a life) indicating a rate in the table is defined uniquely to each company. The value indicated by the information on the life is stored in a certain register included in the eMMC 106. Furthermore, a value calculated by a unique algorithm developed by each maker may be stored in the register. The maker may use a rate obtained by dividing writing capacity obtained at this timing by total writing capacity as the information on the life. For example, in a single level cell (SLC), a hundred thousand times may be ensured as the number of times writing is performed. Furthermore, in a multi-level cell (MLC) setting, the writing life may be 3000 times, for example. A value obtained by dividing the number of times writing is performed by the writing life (the number of times) may be set as the information on the life. Accordingly, the life is set long in the case of the SLC whereas the life is set short in the case of the MLC setting. Specifically, a code in the table of FIG. 6 corresponding to the determined information on the life (defined by the percentage, for example) may be set in the register. The method for calculating the life of the eMMC 106 is merely an example and is not limited to this. Even in a case where the number of time writing is performed is the same, the swap is not restricted in the eMMC set as the SLC whereas the swap may be restricted in the eMMC set as the MLC. The information is monitored by the eMMC life monitoring program 902.

A total amount of data writable to an eMMC drive may be set as an index of a life of the drive. A rate obtained by dividing the writing capacity at this timing by a total amount of data writable to the eMMC drive may be used as a value indicating the information on the life. When the rate exceeds a certain value, the swap may be restricted or stopped.

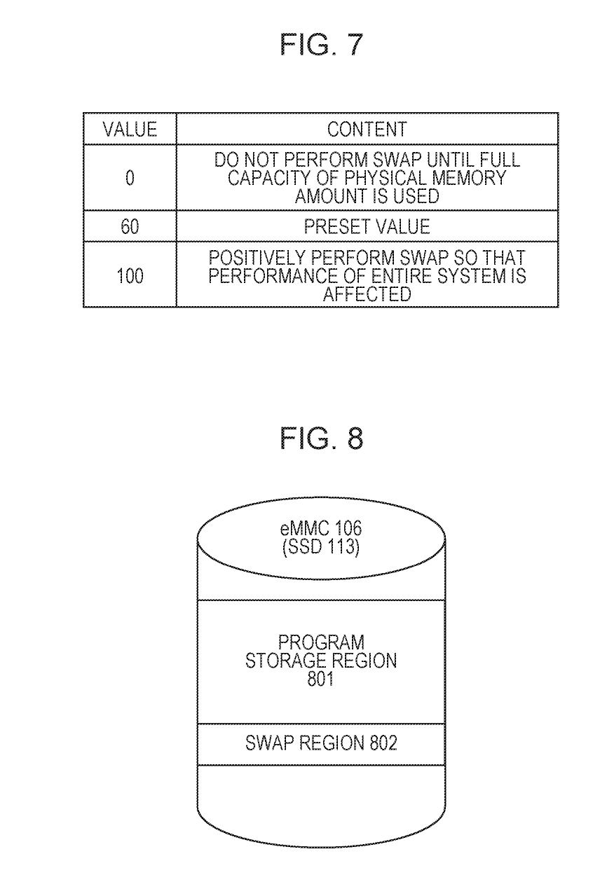

FIG. 7 is a diagram illustrating an example of a swap frequency setting value included in the OS 901 according to this embodiment. Frequency of the swap-in and the swap-out may be changed by setting the swap frequency setting value in a range from 0 to 100. For example, in Linux (registered trademark), Swappiness is defined as a parameter used by a kernel to change frequency of the swap process. A value in a range from 0 to 100 may be set to Swappiness. A prescribed value is 60. If a value of Swappiness is 0, the swap is not performed until the entire memory is used. If a value of Swappiness is 100, the swap process (FIGS. 2 and 3) is positively performed so as to affect the system performance.

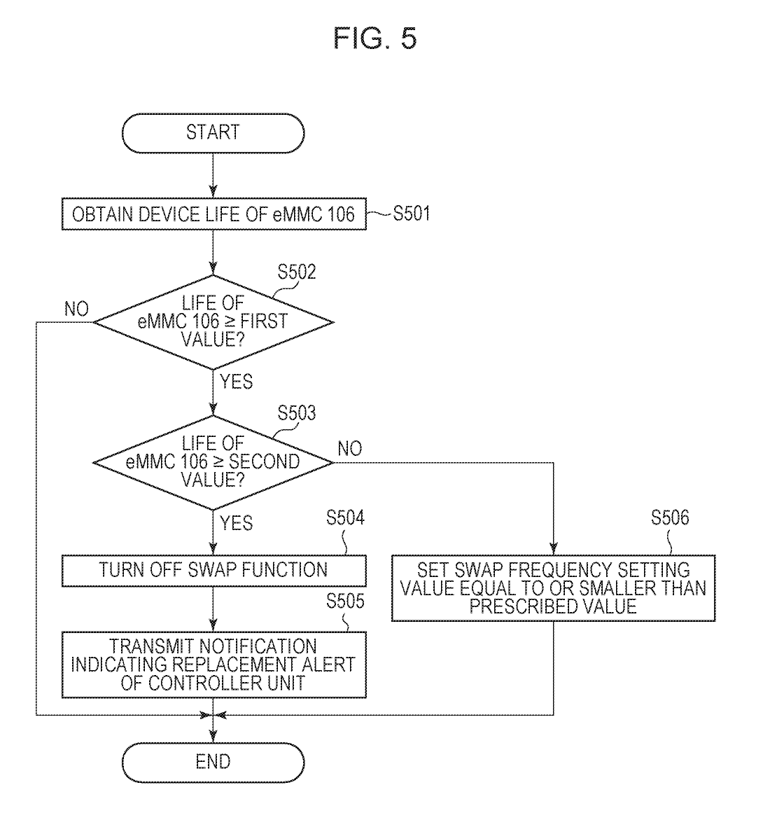

FIG. 5 is a diagram illustrating another example according to this embodiment. FIG. 5 is a flowchart illustrating restriction of the swap function in accordance with change of the device life of the eMMC 106. Although a process described below may be performed by the OS 901 under control of the CPU 101, the process is basically performed as follows. The CPU 101 obtains the device life information from the eMMC 106 under control of the eMMC life monitoring program 902 (S501). The CPU 101 determines whether the obtained device life information is equal to or larger than a first value under control of the eMMC life monitoring program 902 (S502). The device life information is represented as “Used Device Life: 50% to 60%” or the like. When the determination is affirmative in step S502, the process proceeds to step S503. The CPU 101 determines whether the obtained device life information is equal to or larger than a second value under control of the eMMC life monitoring program 902 (S503). When the determination is negative (S503: No), the swap frequency setting value is set to equal to or smaller than the prescribed value (S506).

Specifically, the eMMC life monitoring program 902 instructs the swap function control program 903 to reduce the swap frequency. The swap function control program 903 requests the OS 901 to issue a system call indicating reduction of the swap frequency. In this way, the process in step S506 is realized.

When the determination is affirmative in step S503 (S503: Yes), the swap function is turned off (S504) and a message for prompting replacement of the controller unit 100 is displayed in the operation unit 111 (S505). Specifically, the eMMC life monitoring program 902 instructs the swap function control program 903 to stop the swap function. The swap function control program 903 requests the OS 901 to issue a system call for stopping the swap. In this way, the process in step S504 is realized.

Operation at a time of activation of the OS 901 will now be described. For example, when the eMMC 106 is accessed, the eMMC life monitoring program 902 obtains a value of the device life information register. Here, the obtained value is equal to or larger than 0x06 (Used Device Life: 50% to 60%), the swap frequency setting value is set to a half of the prescribed value so that frequency of the swap is restricted.

FIG. 8 is a diagram illustrating an example of a partition setting of the eMMC 106 according to the embodiment.

A program storage region 801 stores programs (execution files) including the OS 901 and applications.

A swap region 802 managed by the OS 901 is used to execute the swap function described with reference to FIGS. 2 and 3.

As described above, the CPU 101 develops the programs stored in the program storage region 801 in the RAM 103 serving as a work memory so as to execute the programs.

In this case, before the CPU 101 attempts to develop the programs which exceed capacity of the RAM 103, the OS 901 temporarily swaps out a program (a process) which has been developed in the RAM 103 and which is not used to the swap region 802. Furthermore, the OS 901 swaps a program (a process) saved in the swap region 802 in the RAM 103 when a space is generated in the RAM 103.

Here, the swap-out and the swap-in are performed by the OS 901 at arbitrary timings. Here, swap frequency suitable for the system is to be set by tuning the values in FIG. 7.

FIG. 9 is a block diagram illustrating software which realizes the embodiment described above.

The OS 901 which controls the devices connected to the CPU 101 serves as a device driver used to control the various devices. Furthermore, an eMMC device driver 905 controls the eMMC 106, and device drivers 906 control the devices other than the eMMC 106, such as the RTC 105 and the HDD 107.

The eMMC life monitoring program 902 monitors the value of the device life register of the eMMC 106, and the swap function control program 903 turns on or off the swap function of the OS 901 and controls frequency. Furthermore, other system programs 904 display an image on the operation unit 111 and generate and process a digital image.

For example, the device life information of the eMMC 106 described above in the embodiment is obtained by the eMMC life monitoring program 902 periodically or at a specific timing from the eMMC device driver 905 through the OS 901.

Here, when the device life information of the eMMC 106 obtained here indicates the threshold value described above, the eMMC life monitoring program 902 instructs the swap function control program 903 to turn on or off the swap function or control the frequency.

The swap function control program 903 instructs the OS 901 to turn on or off the swap function and controls the frequency in response to the instruction.

Note that this software block diagram is briefly illustrated.

Furthermore, the eMMC life monitoring program 902 and the swap function control program 903 may be integrated as one program or incorporated in another program. For example, the eMMC 106 is replaceable by the SSD 113. The eMMC life monitoring program 902 and the swap function control program 903 may be part of the OS 901 or may be implemented as application services.

Although the image forming apparatus is illustrated as an example in the present disclosure, the present disclosure is applicable to various information processing apparatuses including a personal computer (PC), a mobile terminal, such as a smartphone, and a server instead of the image forming apparatus. Furthermore, although the eMMC 106 is described as an example of a NAND type flash memory, the present disclosure is not limited to this and is applicable to an SSD or a USB memory, for example. Since the eMMC 106 is mainly an on-board implementation which displays a message for prompting replacement of the controller unit 100. Any detachable NAND type flash memory may employ a message indicating part replacement.

Hereinafter, another embodiment using an SSD will be described. This embodiment is different from the foregoing embodiment in that an SSD 113 does not obtain register information of FIG. 6 in step S401 of FIG. 4 or S501 of FIG. 5 but obtains and uses S.M.A.R.T. system information from the SSD 113. The other configurations are basically the same.

The S.M.A.R.T. system employed in the SSD 113, hard disk drives, and the like digitalizes a state of a drive while constantly monitoring the state of the drive. When a numerical value indicated by S.M.A.R.T. is larger than or smaller than a certain numerical value, it may be determined that the state of the drive is unstable. In this case, it may be determined that information on a life exceeds a certain threshold value. A state in which replacement is recommended is entered. When this state is entered, swap may be stopped or restricted. When information indicating an attrition rate of the S.M.A.R.T. information exceeds a certain value, frequency of the swap may be reduced or the swap may be stopped. Examples of the information indicating an attrition rate of the S.M.A.R.T. information include the number of times erasing is performed. For example, the number of times erasing is performed which is indicated by the S.M.A.R.T. information exceeds 70% which is an upper limit value of the number of times erasing may be performed officially announced by a maker, for example, the frequency of the swap may be reduced. Furthermore, when the number of times erasing is performed exceeds 90% which is the upper limit value, the swap may be stopped. Note that the number of times erasing is performed is recognized as an example of information on a life.

As described above, the example of the embodiment is described as follows. The image forming apparatus 1 including the RAM 103 which is an example of a volatile memory and the eMMC 106 which is an example of a nonvolatile storage apparatus is disclosed. The CPU 101 controls the swap process of saving programs in the eMMC 106 serving as a swap region stored in the RAM 103. The CPU 101 obtains the device life information which is an example of the information on the life of the eMMC 106. The CPU 101 restricts the swap process performed by the swap controller in accordance with the device life information. When the device life information indicates that a remaining life of the eMMC 106 is equal to or smaller than a predetermined value, the data saving into the swap region performed by the CPU 101 is restricted. When the device life information indicates that the remaining life of the eMMC 106 is equal to or smaller than the predetermined value, the CPU 101 performs the following process. The CPU 101 operates a parameter of a command relating to Swappiness instructed relative to the OS 901 so as to restrict data saving into the swap region performed by the CPU 101.

When the device life information indicates that the remaining life of the eMMC 106 is equal to or smaller than the predetermined value, the CPU 101 may stop the data saving into the swap region performed by the CPU 101. The eMMC 106 may be implemented on the controller unit 100 in the image forming apparatus 1.

Furthermore, when the device life information indicates that a remaining life of the nonvolatile storage apparatus is equal to or smaller than a predetermined value, at least a swap process which is newly performed by the CPU 101 is stopped. Thereafter, the CPU 101 may issue a notification indicating replacement of the controller unit 100. A result is displayed in the operation unit 111 of the image forming apparatus 1.

The information on the life of the eMMC 106 may correspond to the number of times erasing is performed on the eMMC 106 or the number of times writing is performed on the eMMC 106. Furthermore, when the number of times erasing is performed on the eMMC 106 or the number of times writing is performed on the eMMC 106 exceeds a predetermined number of times, the CPU 101 may reduce the frequency of the swap. The eMMC 106 is replaceable by the SSD 113.

A total amount of data writable to the SSD 113 may be set as one of indices of a drive life. A rate obtained by dividing writing capacity at this timing by a total amount of data writable to the SSD 113 may be used as the information on a life. When the rate exceeds a certain value, the swap may be restricted or stopped.

According to this embodiment, stable operation of the recording apparatus may be realized. For example, in the present disclosure, degradation of performance of the system may be prevented while reduction of a life due to the writing process frequently performed on the storage apparatus is avoided.

As described above, the swap region is used to temporarily save a program (a process) which is not used when physical memory capacity is lacked. It is difficult to predict a degree of occurrence of replacement into the swap region since the swap function is executed at an arbitrary timing when the physical memory capacity is lacked. In view of these situations, the following situations may be addressed by this embodiment.

A situation in which reduction of the life of the storage apparatus is greater than expected when the number of times in which the storage region is accessed is large may be addressed. A situation in which the life of the storage apparatus is reduced when writing to the storage apparatus based on the swap process frequently performed may be addressed.

Performance of the system is not degraded while reduction of the life due to the writing process frequently performed on the storage apparatus is avoided. Accordingly, stable operation of the storage apparatus may be realized.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-054884 filed Mar. 21, 2017, which is hereby incorporated by reference herein in its entirety.

What is claimed is:

1. An apparatus including a volatile memory and a nonvolatile storage device, the apparatus comprising:
a controller configured to control a swap process of saving data stored in the volatile memory into a swap region included in the nonvolatile storage device; and
a restriction unit configured to restrict the swap process in accordance with information on a life of the nonvolatile storage device.

2. The apparatus according to claim 1, wherein the restriction unit restricts saving of data into the swap region when the information indicates that a remaining life of the nonvolatile storage device is equal to or smaller than a predetermined value.

3. The apparatus according to claim 1, wherein the restriction unit restricts saving of data into the swap region by operating a parameter of a command relating to Swappiness instructed to an operating system when the information indicates that a remaining life of the nonvolatile storage device is equal to or smaller than a predetermined value.

4. The apparatus according to claim 1, wherein the restriction unit stops saving of data into the swap region when the information indicates that a remaining life of the nonvolatile storage device is equal to or smaller than a predetermined value.

5. The apparatus according to claim 3,
wherein the nonvolatile storage device is implemented on a control board of the apparatus, and
the apparatus further includes a notification unit configured to transmit a signal for displaying a notification for prompting replacement of the control board in an operation unit of the information processing unit while at least a swap process newly performed is stopped when the information indicates that a remaining life of the nonvolatile storage device is equal to or smaller than a predetermined value.

6. The apparatus according to claim 1, wherein the information on the life of the nonvolatile storage device indicates the number of times erasing is performed on the nonvolatile storage device or the number of times writing is performed on the nonvolatile storage device, and when the number of times erasing is performed on the nonvolatile storage device or the number of times writing is performed on the nonvolatile storage device exceeds the predetermined number of times, the controller reduces frequency of swap.

7. A method for controlling an apparatus including a volatile memory and a nonvolatile storage device, the method comprising:
controlling a swap process of saving data stored in the volatile memory into a swap region included in the nonvolatile storage device; and
restricting the swap process in accordance with information on a life of the nonvolatile storage device.

8. The method according to claim 7, wherein the restricting restricts saving of data into the swap region when the information indicates that a remaining life of the nonvolatile storage device is equal to or smaller than a predetermined value.

9. The method according to claim 7, wherein the restricting restricts saving of data into the swap region by operating a parameter of a command relating to Swappiness instructed to an operating system when the information indicates that a remaining life of the nonvolatile storage device is equal to or smaller than a predetermined value.

10. The method according to claim 7, wherein the restricting stops saving of data into the swap region when the information indicates that a remaining life of the nonvolatile storage device is equal to or smaller than a predetermined value.

11. The method according to claim 9, further comprising:
implementing the nonvolatile storage device on a control board of the apparatus; and
transmitting a signal for displaying a notification for prompting replacement of the control board in an operation unit of the information processing unit while at least a swap process newly performed is stopped when the information indicates that a remaining life of the nonvolatile storage device is equal to or smaller than a predetermined value.

12. The method according to claim 7, wherein the information on the life of the nonvolatile storage device indicates the number of times erasing is performed on the nonvolatile storage device or the number of times writing is performed on the nonvolatile storage device, and when the number of times erasing is performed on the nonvolatile storage device or the number of times writing is performed on the nonvolatile storage device exceeds the predetermined number of times, the controller reduces frequency of swap.

13. A computer readable storage medium storing a computer-executable program of instructions for causing a computer to perform a method for controlling an apparatus including a volatile memory and a nonvolatile storage device, the method comprising:
controlling a swap process of saving data stored in the volatile memory into a swap region included in the nonvolatile storage device; and
restricting the swap process in accordance with information on a life of the nonvolatile storage device.

14. The computer readable storage medium according to claim 13, wherein the restricting restricts saving of data into the swap region when the information indicates that a remaining life of the nonvolatile storage device is equal to or smaller than a predetermined value.

15. The computer readable storage medium according to claim 13, wherein the restricting restricts saving of data into the swap region by operating a parameter of a command relating to Swappiness instructed to an operating system when the information indicates that a remaining life of the nonvolatile storage device is equal to or smaller than a predetermined value.

16. The computer readable storage medium according to claim 13, wherein the restricting stops saving of data into the swap region when the information indicates that a remaining life of the nonvolatile storage device is equal to or smaller than a predetermined value.

17. The computer readable storage medium according to claim 15, further comprising:
implementing the nonvolatile storage device on a control board of the apparatus; and
transmitting a signal for displaying a notification for prompting replacement of the control board in an operation unit of the information processing unit while at least a swap process newly performed is stopped when the information indicates that a remaining life of the nonvolatile storage device is equal to or smaller than a predetermined value.

18. The computer readable storage medium according to claim 13, wherein the information on the life of the nonvolatile storage device indicates the number of times erasing is performed on the nonvolatile storage device or the number of times writing is performed on the nonvolatile storage device, and when the number of times erasing is performed on the nonvolatile storage device or the number of times writing is performed on the nonvolatile storage device exceeds the predetermined number of times, the controller reduces frequency of swap.
